(19) United States
(12) Patent Application Publication
(10) Pub. No.: US 2016/0217526 A1
(43) Pub. Date: Jul. 28, 2016

(54) Methods and Systems for the Calculation and Presentation of Time Series Study Information

(71) Applicant: TRADING TECHNOLOGIES INTERNATIONAL INC., Chicago, IL (US)

(72) Inventor: Stephen P. DECKER, Naperville, IL (US)

(21) Appl. No.: 14/605,451

(22) Filed: Jan. 26, 2015

(51) Int. Cl. G06Q 40/04; G06T 11/20

(52) U.S. Cl. CPC G06Q 40/04; G06T 11/206

(57) ABSTRACT

Methods and systems for the calculation and display of time study information are disclosed herein. An example method includes receiving, at a computing device, a first market data update providing a first candlestick definition for a first time period, wherein the first market data update relates to a tradeable object offered at an exchange. The example method includes calculating, at the computing device, a baseline value related to the tradeable object, wherein the baseline value is based on the first market data update. The example method includes calculating, at the computing device, a second candlestick definition based on the first candlestick definition and the calculated baseline value. In the example method, the second candle stick definition is for a second time period different from the first time period. The example method includes defining, at the computing device, first and second candlesticks based on respective first and second candlestick definitions. The example method includes displaying the defined first candlestick relative to the defined second candlestick as a part of a graphical representation of the market data update.

### BACKGROUND

An electronic trading system generally includes a trading device in communication with an electronic exchange. The trading device receives information about a market, such as prices and quantities, from the electronic exchange of a tradeable object of the electronic exchange. The electronic may send or update such information to the trading device. The electronic exchange attempts to match quantity of an order with quantity of one or more contra-side orders.

Manipulation and display of market data such as quantities, prices and/or trends in prices and quantities provide a trader with the information necessary to make effective decisions. Trading information related to a tradeable object offered by an exchange may be graphically displayed as a graphical representation known as a candlestick. A candlestick may be generated based on, for example, an open, value a high value, a low value, and a close value. Known data representations often present time series study information in terms of a single value intended to reflect the multiple values contained within the trading information.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a flow diagram representative of example machine readable instructions that may be executed to implement disclosed embodiments.

FIG. 5 illustrates another flow diagram representative of example machine readable instructions that may be executed to implement disclosed embodiments.

FIG. 6 illustrates an example representation of data calculations to determine time study information of a tradeable object.

FIGS. 7a and 7b illustrate example trading display interfaces.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

This patent document relates generally to electronic trading displays and, more particularly, to methods and systems for the calculation and presentation of time series study information. The examples disclosed herein provide a mechanism by which visual indicators representative of time study information can be calculated and displayed to inform or alert a trader of market trends (e.g., momentum trends, trends at different time scales, shifts of a tradeable object and/or shifts in the market, etc.) in an easy to discern visual representation.

Trading data includes market data and derived values representative of a tradeable object of an exchange is typically aggregated into “rolled up” bars, which may be implemented using various methods and vary by time (e.g., minutes, days week, etc.), by volume, by ticks (e.g., the number of data points), and/or by price. Current technical studies based on active trading data or stored trading data, such as bar rollup data, produce a single value output representative of the multiple values contained in the bar rollup data. In known examples, a momentum study of a value such as a close value involves subtraction of a previous close value from a current close value to calculate a rate of change.

Some current approaches apply multiple calculations to the same output value (e.g., a momentum study that produces “raw’ and “smoothed” values within the same study output). The smoothed values may be compared against raw values to determine if study values are trending higher or lower.

The examples disclosed herein enable creation of technical studies based on multi-variable input such as bar data, and/or candlestick data, to create a multi-variable output as bar data to be visualized as graphical representations. For example, an input bar consisting of four OHLC values (e.g., an open value, a high value, a low value, and a close value) may be used as multi-variable inputs to define a study that generates a multi-variable output, such as the four OHLC values, and other trend-indicating values that define output bar data. Such output bar data may be displayed as an output bar simultaneously and/or adjacent to the input bar. In other words, the example embodiments disclosed herein allow multiple trend indicating values to be generated based on corresponding OHLC values and/or an input bar (e.g., an input candlestick, an input candlestick definition, etc.). In some example embodiments, a candlestick representing typical OHLC values is displayed adjacent a time study representation (e.g., trend-indicating candlestick, calculated candlestick, etc.) that indicate time studies of the corresponding candlestick representing typical OHLC values. In other examples, the candlestick representing typical OHLC values and the trend-indicating time-study representation are simultaneously displayed on different charts (e.g., the charts are vertical or horizontal to one another, etc.).

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Certain embodiments provide an example method including receiving, at a computing device, a first market data update providing a first candlestick definition for a first time period, where the first market data update relates to a tradeable object offered at an exchange. The example method includes calculating, at the computing device, a baseline value related to the tradeable object, where the baseline value is based on the first market data update. The example method includes calculating, at the computing device, a second candlestick definition based on the first candlestick definition and the calculated baseline value. In the example method, the second candle stick definition is for a second time period different from the first time period. The example method includes defining, at the computing device, first and second candlesticks based on respective first and second candlestick definitions. The example method includes displaying the defined first candlestick relative to the defined second candlestick as a part of a graphical representation of the market data update.

Certain embodiments provide an example computing device including a user interface to receive or determine a first candlestick definition of a first time period, where the first candlestick definition is based on market update data that relates to a tradeable object offered at an exchange. The example computing device also includes a processor to calculate a baseline value related to the tradeable object, where the baseline value is calculated based on a portion of the market update data corresponding to a second time period, and the second time period is different from the first time period. The processor of the example computing device is to also calculate a second candlestick definition of the second time period based on the baseline value and the first candlestick definition. The user interface of the example computing device is to display graphical representations including first and second candlesticks representative of the first and second candlestick definitions, respectively. In the example computing device, the candlestick graphical representations are to be displayed relative to one another.

Certain embodiments provide an example tangible machine readable medium having instructions stored thereon, which when executed cause a machine to receive a first set of market data defining a first candlestick definition for a first time period, where the first set of market data relates to a tradeable object offered at an exchange. The example instructions cause the machine to calculate a baseline value related to the tradeable object, where the baseline value is based on the first set of market data. The example instructions cause the machine to calculate, at the computing device, a second candlestick definition based on a difference between values of the first candlestick definition and the calculated baseline value, where the second candlestick definition is for a second time period that is different from the first time period. The example instructions cause the machine to define first and second candlesticks based on respective first and second candlestick definitions. The example instructions cause the machine to display the defined first candlestick relative to the defined second candlestick as a graphical representation of the market data update.

### II. Example Electronic Trading System

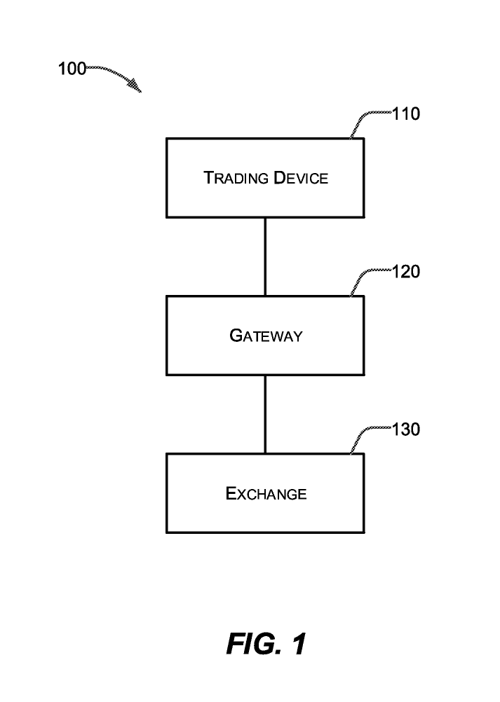

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device maybe executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the IntercontinentalExchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

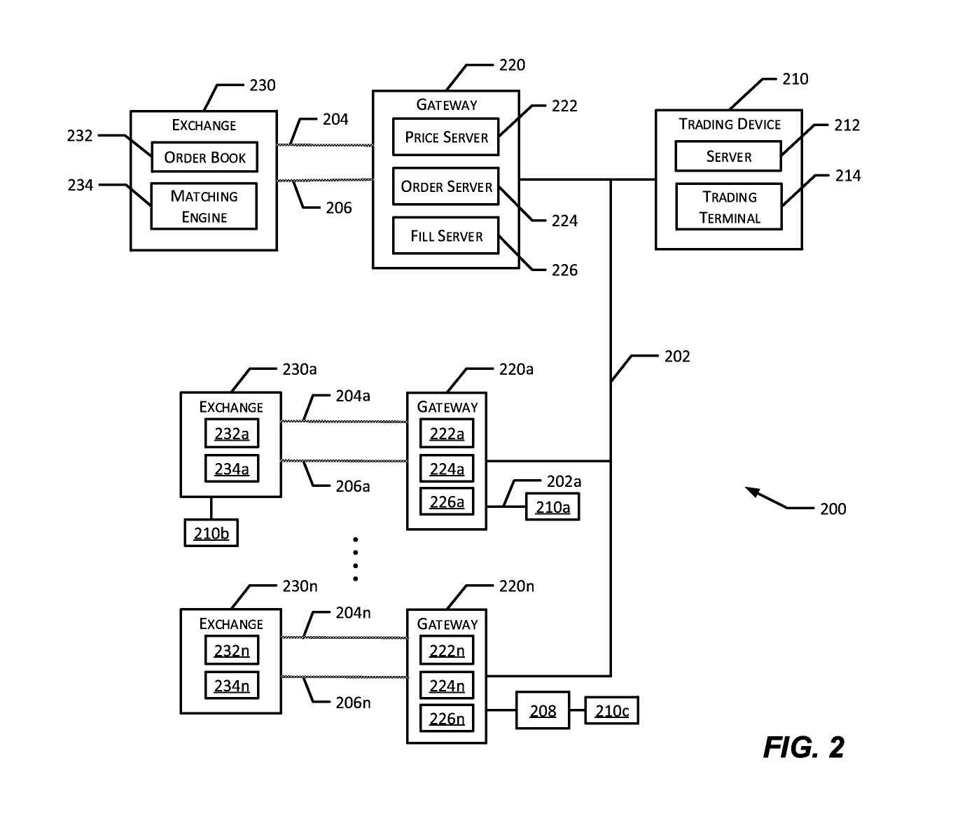

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

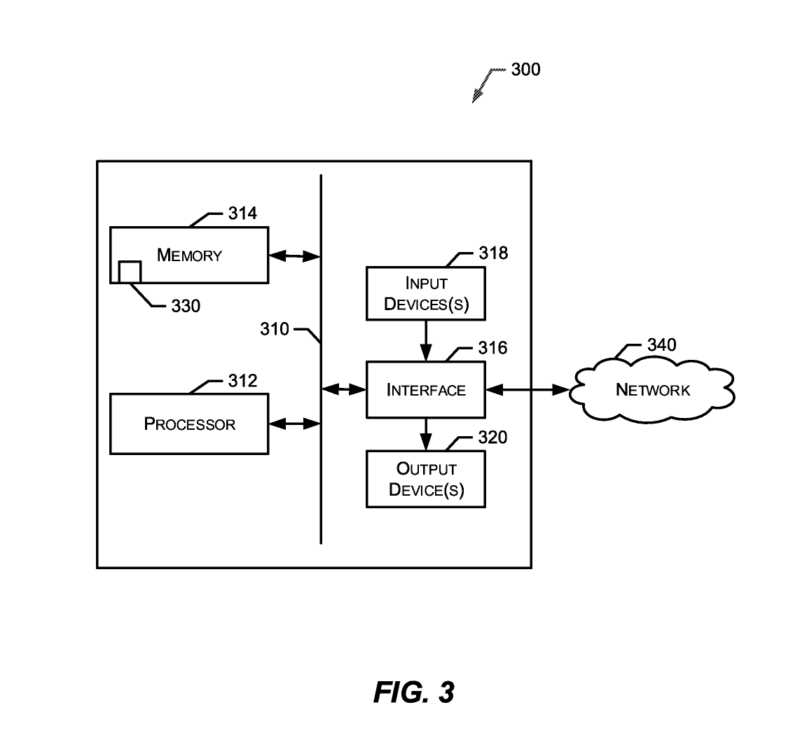

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Calculation and Presentation of Time Series Study Information

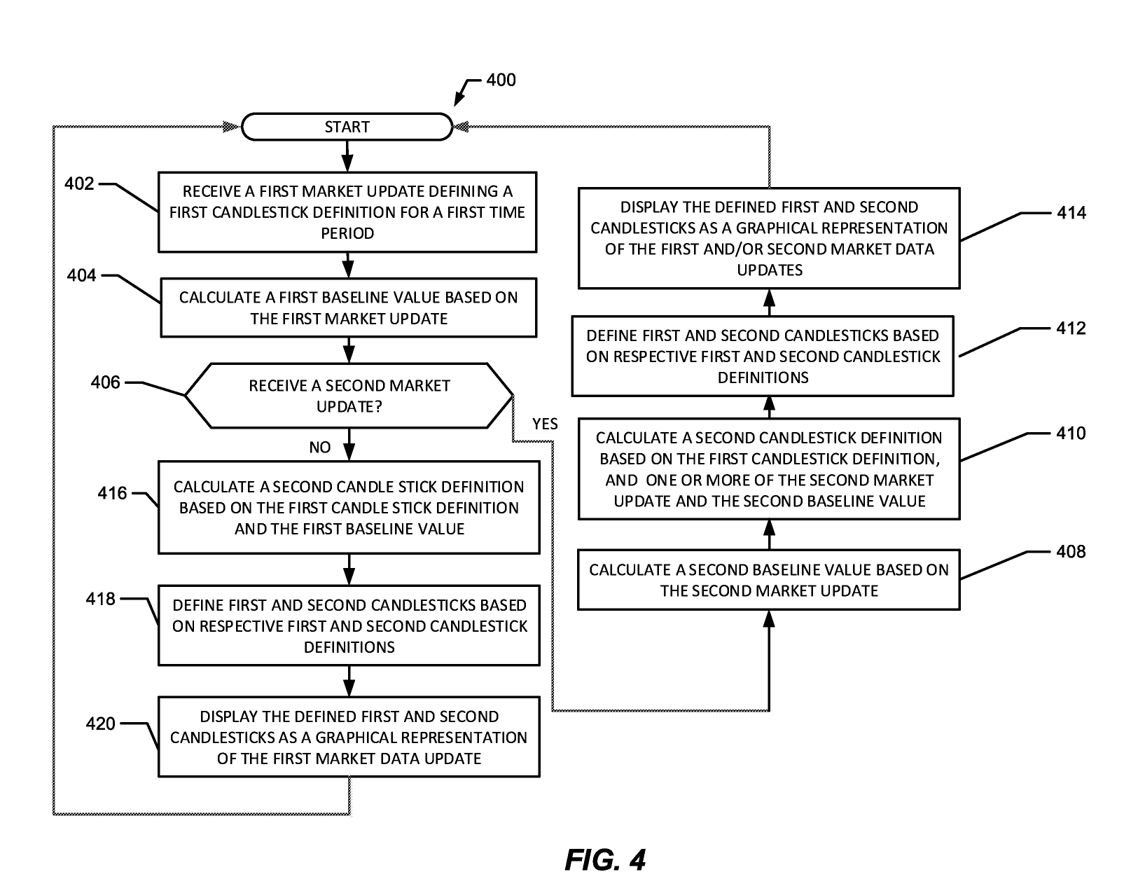

FIG. 4 is a flow chart representative of example operations that can be executed to implement the teachings of this disclosure. The example operations allow time series studies representative of the trading activity of a tradeable object to be calculated and displayed (e.g., displayed contemporaneously). The example operations of FIG. 4 can be implemented by, for example, the trading device 110 of FIG. 1 and/or the trading devices 210, 210a-210n of FIG. 2. While the trading device 110 of FIG. 1 is described as executing the example operations of FIG. 4 below, any suitable device can execute the examples operations of FIG. 4. The example operations of FIG. 4 calculate and/or generate time study information such as candlestick definitions and/or nested candlestick definitions to provide a user with an easy-to-visualize graphical representation of trends. In other words, the calculated candlestick definitions and/or candlestick representations may be used to indicate momentum and/or momentum shifts of the tradeable object, for example.

In the example of FIG. 4, a first market update is received. The first market update of the illustrated example is used to define and/or provide a first candlestick definition for a first time period. In this example, the first market update includes numerous data points including open, close, high and low values (e.g., the aforementioned OHLC values, etc.). In this example, a baseline value is calculated based on the first market update and a second candlestick definition is generated using either the baseline value based on the first market update or a baseline value based on a second market update. In either scenario, the second candlestick is based on the first candlestick definition and the first and second candlesticks are displayed simultaneously. While the first market update of the illustrated example includes data sets related to open, high, low and close values, data used for calculations in the examples disclosed herein may, additionally or alternatively, include other values such as volume indicators, time differentials, etc. and/or values derived from the open, high, low and close values.

The example process 400 of FIG. 4 begins at block 402 where a trading device such as the example trading device 110 of FIG. 1 receives a first market update of a tradeable object offered at an exchange. In some examples, the trading device receives the first market update and/or additional market updates from the exchange. In some examples, the first market update may include a single data set (e.g., open, high, low and close values of a single time period or a single hour or day, etc.) or data pertaining to a plurality of time periods (e.g., multiple open, high, low and close values of different time intervals, a table, time history, etc.). In this example, the first market update defines a first candlestick definition corresponding to a first time period. While the first market update of the illustrated example defines the first candlestick definition, in other examples, the first candlestick definition may be derived and/or calculated from the first market update by a device such as the trading device 110 of FIG. 1.

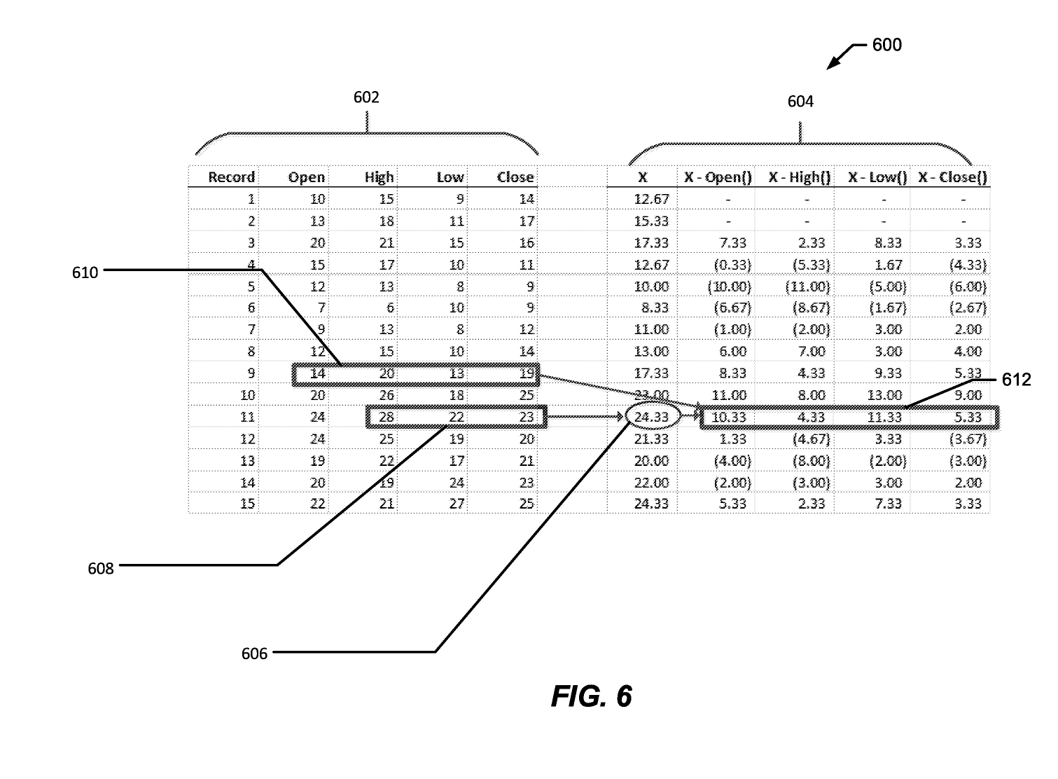

At block 404, a baseline value is calculated based on the first market update. The baseline value of the illustrated example may be a numerical characterization of certain values associated with a time period such as an average of high, low and close values at the time period calculated by arithmetic operations, for example. FIG. 6 describes an example representation of a calculation to determine a baseline value.

Turning to FIG. 6, a graphical representation 600 of one example of baseline calculations in accordance with the teachings of this disclosure is shown. The example representation 600 includes a chart 602 of raw data of a tradeable object offered at an exchange and a chart 604 of calculated and/or generated trend-indicating time study values (e.g., values to illustrate and/or discern shifts, trends and/or movement of the tradeable object). The chart 602 of the illustrated example has columns representing a record number, and open, high, low and close values of the tradeable object. In this example, the record numbers correspond to time periods (months, days, hours, minutes, months, etc.). In this example, a baseline value 606 is calculated by averaging values 608 including high, low and close values at a time period (e.g., time interval, etc.) represented by record number 11, for example. The baseline value of the illustrated example is listed in the column identified by “X” shown in chart 604. In other embodiments, the baseline value may be calculated based on a previous record number. In another embodiment, the baseline value may be filtered to remove or normalize outlier values. Outliers may be determined based on a calculated standard deviation or other derived value. In other embodiments, the baseline value may be calculated based on traded volume at price information such as a volume weighted average price (VWAP).

Returning to FIG. 4, at block 406, it is determined whether a second market update is received and/or provided. The second market update may be data related to a single time period (e.g., a day, an hour, a minute, etc.) or multiple time periods (e.g., a set of multiple data points). Such a determination of whether the second market update has been received may occur at the device 110, the gateway 120 and/or the exchange 130 of FIG. 1, for example. While the baseline value of the illustrated example is calculated as an average of high, low and close values, in some examples, a baseline value is calculated by other operations, other parameters, averaging values of different time steps, interpolated values, and/or weighted averages, etc.).

If the second market update is received, at block 408, in some examples, a second baseline value based upon the second market update is calculated. In other examples, the second baseline value is not calculated and/or determined. Additionally or alternatively, the calculated first baseline value is still to be later used for further calculation(s) and/or determination(s). In some examples, the second market update may be one or more rows added to charts such as the charts 602 and 604 of FIG. 6.

At block 410, a time-study indicator such as a second candlestick definition, for example, is calculated. In this example, the second candlestick definition is calculated based on the first candlestick definition and the second baseline value. Additionally or alternatively, the second candlestick definition may be calculated based on the second market update and/or indexed values of the second market update. In some examples, the second candlestick definition is calculated based on the first baseline value. In this example, values associated with the first candlestick definition such as open, high, low and close values are subtracted from either the first or second baseline value to define time study trend-indicating open, high, low and close values associated with the second candlestick definition. In some examples, the second candlestick definition is based on arithmetic operations (e.g., subtraction, subtraction of averages, etc.) between multiple candlestick definitions (e.g., deltas, averages and/or weighted averages of several candlestick definitions and/or values associated with the candlestick definitions). Definition of the second candlestick may be dependent on indicating trends that are valuable to a trader and/or shifts and/or movements in the tradeable object that may be difficult to process and/or visualize by the trader, for example. In some examples, definition of the second candlestick is based on certain condition(s) such as time of the day, volatility of a market and/or market or tradeable object patterns and/or shifts, for example. These condition(s) can be used for dynamic adaptation of candlestick definition and/or generation, for example. In some examples, the time periods have a short duration (e.g., on the order of milliseconds, etc.) and/or market updates are provided (e.g., periodically provided) over the course of a few milliseconds to the trading device, for example, and the second candlestick definition is updated over such intervals with a short duration.

Turning back to FIG. 6, an example representation of a calculation is shown to determine a time-study trend indicator such as a second candlestick definition, for example. In the illustrated example of FIG. 6, trend indicating values 612 that indicate a shift are calculated via an arithmetic operation such as by subtracting values 610 from the calculated baseline value 606. The trend indicating values 612 (e.g., the resultant values) yielded are denoted by X-Open, X-High, X-Low and X-Close, which are trend indicating values that correspond to open, high, low and close values, etc. In some examples, the trend indicating values (e.g., the time study values, etc.) 612 may be used to derive and/or calculate a second candlestick definition.

In this example, the trend indicating values define (e.g., are equivalent to) the second candlestick definition and indicate a momentum shift of each type of indicator (e.g., open, high, low and close values, etc.). While a subtraction operation is shown in this example, any mathematical operation may be performed including, but not limited to, weighted averages, differentials, scalar multiplication, time-averaging, etc. Additionally, any of these operations may be applied to numerous time steps (e.g., numerous rows of charts 602, 604). In particular, the trend indicating values 612 may calculated numerous time steps (e.g., multiple rows of the charts 602, 604) by time-averaging and/or interpolating numerous values, for example, at different time steps. In some examples, the trend indicating values 612 are based on interpolations and/or predicted values determined by techniques such as linear regression, etc.

In other examples, multiple candlesticks may be generated simultaneously. For example, an additional third candlestick definition may be generated to indicate a trend over a different time scale from the second candlestick definition. Generating multiple candlestick definitions may allow a trader to simultaneously view different trends over differing time scales. In some examples, the trend indicating values are calculated using time-based derivatives of data from the first chart 602 and/or data from the second chart 604.

Returning to FIG. 4 at block 412, first and second candlesticks are defined based on the first and second candlestick definitions, respectively. In this example, the first candlestick definition is based on the open, high, low and close values of the tradeable object at a first time period. The second candlestick of the illustrated example is based on calculated trend-indicating values corresponding to open, high, low and close values (e.g., modified and/or shifted open, high, low and close values).

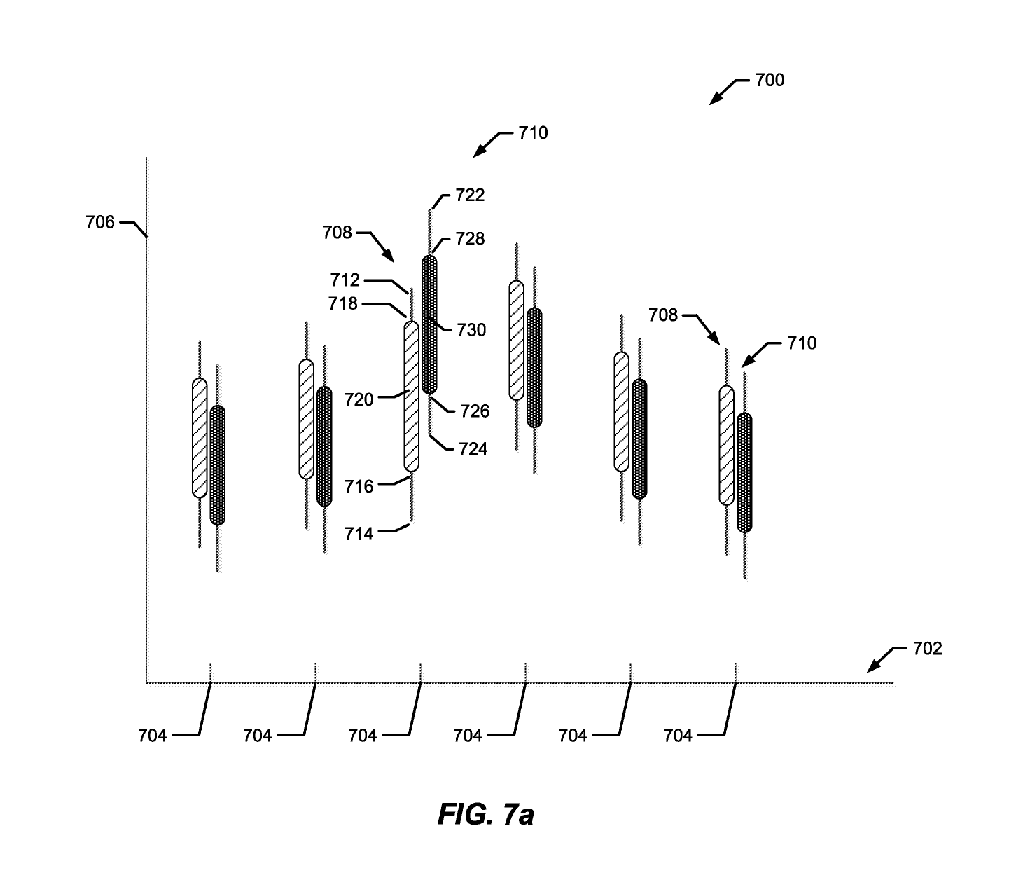

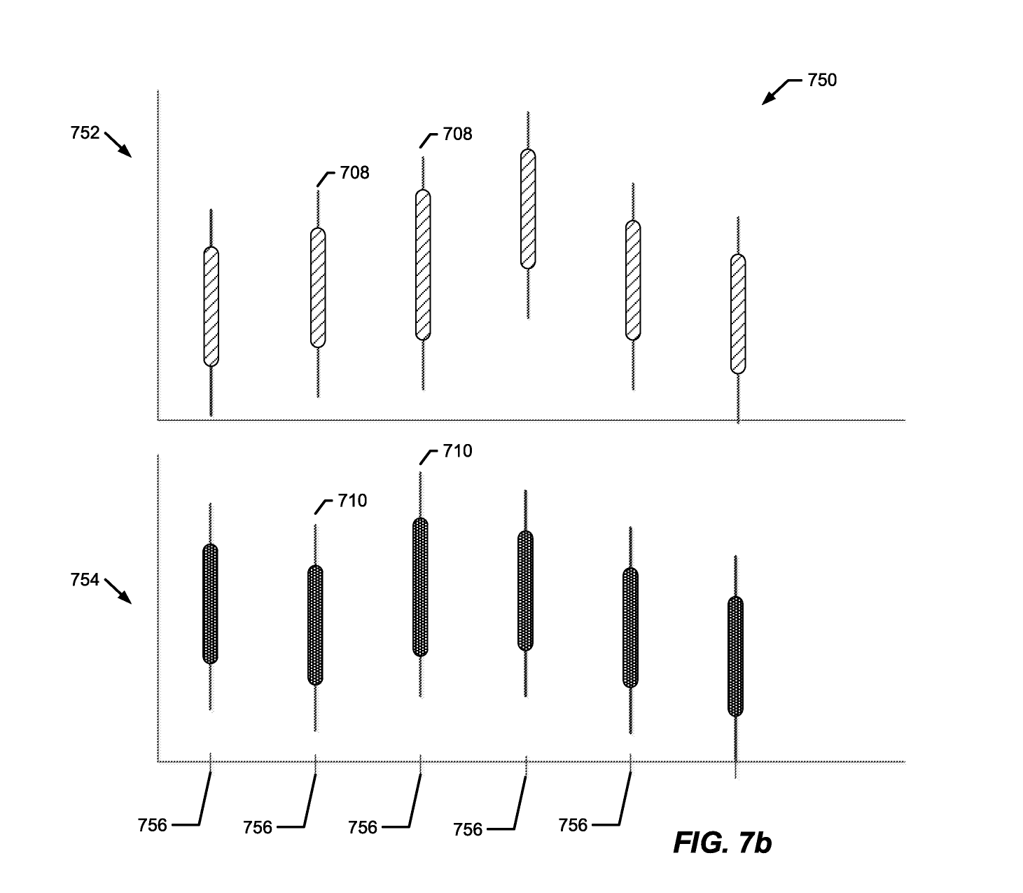

At block 414, the defined first and second candlesticks are displayed as graphical representations of the first and/or second market updates. The first and second candlesticks may alternatively be shown over multiple displays. Example candlestick display interfaces are described in detail below in connection with FIGS. 7a and 7b.

FIG. 7a illustrates a first example candlestick display 700 in accordance with the teachings of this disclosure. The horizontal axis 702 of the illustrated example has ticks 704 to indicate time intervals. In this example, the vertical axis 706 indicates price of a tradeable object offered at an exchange. Each time interval of the illustrated example includes a first candlestick 708 and a second candlestick 710, both of which are arranged relatively adjacent to one another, for example. Each of the first candlesticks 708 include a high value 712, a low value 714, an open value 716 and a close value 718. In this example, the open value 716 and the close value are depicted by body 720 to provide visual information that is easily discerned by a trader. The high value 712 and the low value 714 define upper and lower shadows, respectively, in relation to the body 720. Similar to each of the first candlesticks 708, each of the second candlesticks 710 have a corresponding high value 722, a low value 724, an open value 726 and a close value 728, and a respective visual body 730. While the tick marks 704 of the illustrated example are shown in a relatively uniform matter, in some examples, they may be uneven or shown on a logarithmic scale. While the first candlesticks 708 and the second candle sticks 710 are shown on the same scale, in some examples, they may be displayed on different scales relative to one another.

The example candlestick display 700 of the illustrated example allows visualization of both the first candlesticks 708, which may correspond to open, high, low and close values of a time period, relative to the second candlesticks 710, which may depict corresponding trend-indicating values of the open, high, low and close values, respectively.

FIG. 7b illustrates a second example candlestick display 750 in accordance with the teachings of this disclosure. In contrast to the example candlestick display 750, the first candlesticks 708 are placed on a first chart 752 separate from the second candlesticks 710 that are placed on a second chart 754. In this example, both the first chart 752 and the second chart 754 are shown on the same display. The example candlestick display shows both the first candlesticks 708 and the second candlesticks in a relative vertical direction to one another (e.g., a vertical direction corresponding to each time period) at each respective time tick 756. In some examples, the vertical axes of the chart 752 and the chart 754 are scaled differently relative to one another. Such an arrangement, in some examples, may allow a trader to quickly distinguish trend-shifts in momentum as opposed to trends in the open, high, low and close values. While the example of FIG. 7b illustrates the first chart 752 and the second chart 754 being in a vertical arrangement to one another, in other examples, they may be in a horizontal or diagonal relative arrangement to one another. While two charts are shown in the illustrated example, any number of candlesticks, nested candle sticks (e.g., trend indicators of other trend-indicating candlesticks, etc.), and/or charts pertaining to candle sticks may be displayed.

Turning back to FIG. 4, if a second market update is not received and/or the trading device is waiting for the second market update to be received (block 406), then, in this example, a second candlestick definition may still be calculated at block 416. In this example, the second candlestick definition is calculated based on the first candlestick definition and the first baseline value.

At block 418, first and second candlesticks are defined based on the first and second candlestick definitions, respectively. In this example, the first candlestick definition is based on the open, high, low and close values of the tradeable object at a first time period. The second candlestick of the illustrated example is based on calculated time study trend-indicating values corresponding to open, high, low and close values (e.g., modified and/or shifted open, high, low and close values) based on a second time period of the first market update.

At block 420, the defined first and second candlesticks are displayed together as a graphical representation such as the example graphical representations 700 and 750 described in connection with FIGS. 7a and 7b, respectively.

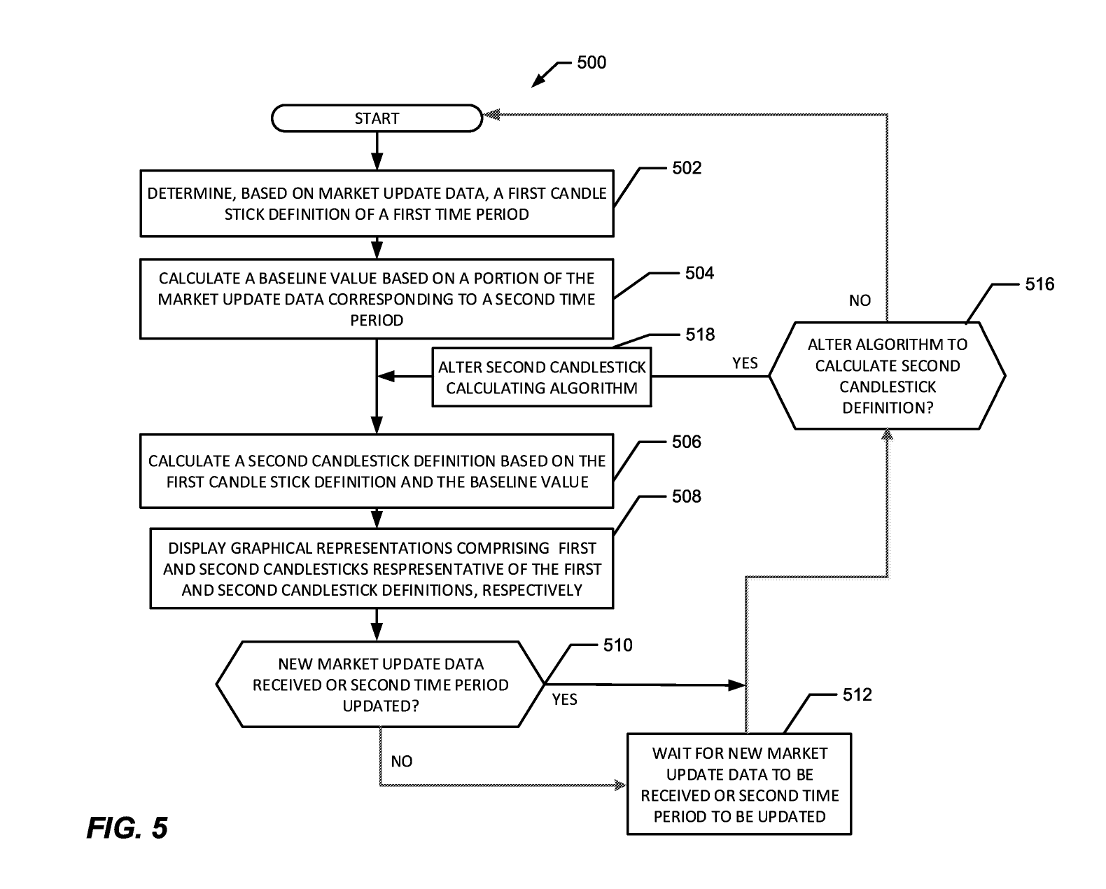

FIG. 5 is another flow chart representative of example operations that can be executed to implement the teachings of this disclosure. The example operations allow time studies of a tradeable object of an exchange to be calculated and displayed (e.g., displayed contemporaneously) and also allow the manner in which time studies are calculated and/or defined to be adjusted and/or altered. The example operations of FIG. 5 can be implemented by, for example, the trading device 110 of FIG. 1 and/or the trading devices 210, 210a-210n of FIG. 2. While the trading device 110 of FIG. 1 is described as executing the example operations of FIG. 5 below, any suitable device can execute the operations. The example operations of FIG. 5 calculate and/or generate time study information such as candlestick definitions and/or nested candlestick definitions to provide a user with an easy-to-visualize graphical representation of trends and/or allow time study algorithms to be altered and/or adjusted based on conditions such as market conditions, volume and/or volatility, etc.

The example process 500 begins at block 502 where a trading device such as the example trading device 110 of FIG. 1 determines a first candlestick definition of a first time period based on a received market update of a tradeable object offered at an exchange. The first candlestick definition may be generated by simply indexing open, high low and close values corresponding to a first time period of the market update or they may be calculated and/or determined by values of the market update. In some examples, multiple values may be used to derive the first candlestick definition (e.g., timed data may be averaged and/or weighted together, etc.).

At block 504, a baseline value based on a portion of the market update corresponding to a second time period is calculated. The baseline data of the illustrated example may be calculated as described with respect to FIG. 6.

At block 506, a second candlestick definition is calculated based on the first candlestick definition and the baseline value. The second candlestick definition may be calculated as in or similar to the example calculation described with respect to FIG. 6.

At block 508, graphical representations including first and second candlesticks representative of the first and second candlestick definitions are displayed together. The first and second candlesticks may be displayed such as the example candlestick displays 700 and 750 described in connection with FIGS. 7a and 7b, respectively.

At block 510, market data is analyzed to determine whether a new market update (e.g., an updated and/or revised) is received or if the second time period has been updated (e.g., whether the second reference time period has changed). A trading device (e.g., trading device 110) may perform or execute the determination by querying and/or accessing information by an exchange (e.g., the exchange 130) via a gateway (e.g., the gateway 120), for example. In some examples, the new market update may be received in a periodic fashion or there may be times in the day where the frequency of market updates increases or decreases (e.g., frequency of market updates based on times of the day, market conditions, volatility, etc.). In some examples, a change in the second time period may occur as a result of trader input at the trading device.

If a new market update is not received (block 510), then the trading device may wait (e.g., wait for a defined time period) to receive the new market update. In some examples, not receiving the new market update may trigger the trading device to query and/or ping the exchange for a new market update. In some examples, the process proceeds to block 516, where it is determined whether to modify and/or select a second candlestick definition defining algorithm.

If a new market update is received (block 510), in some examples, the process proceeds to block 516, where it is determined whether to modify and/or select a second candlestick definition algorithm.

At block 516, in some examples, the trading device and/or the exchange 130 may determine whether to change, select and/or alter the algorithm that defines how the second candlestick definition is determined or calculated. For example, the algorithm to define the generation of a second candlestick definition may be altered and/or selected based on overall market conditions or trends, shifts in a related business sector and/or trends related to the tradeable object. Additionally or alternatively, the candlestick definition algorithm may also be adjusted to vary over a time period in which the second candlestick definition is calculated (e.g., the time period range, time of day, time to market close, etc.). In some examples, the second candlestick definition algorithm is dynamically changed during the example process 500. In some examples, the second candlestick definition algorithm is independently changed of the process steps of the example process 500 (e.g., the second candlestick definition algorithm is changed or selected at any time when changed parameters related to market conditions, market trends, etc. are indicated).

In some examples, if it is determined that the second candlestick definition algorithm is to be altered, at block 518, the second candlestick definition algorithm is altered and/or modified and the second candlestick definition is re-calculated at block 506. In some examples, the algorithm may define multipliers that vary based on conditions and/or defined parameters, for example, to scale the time study trend-indicating open, high, low and close values, etc.

Likewise, if it is determined that the second candlestick defining algorithm is not to be altered or modified, the process repeats. In some examples, the process is repeated in milliseconds or even smaller intervals.

In an example scenario, a trader is monitoring a tradeable object X that is being offered at an exchange. The trader views open, high, low and close values on her electronic trading device (e.g., the device 110 of FIG. 1). The trader would like to view time study values corresponding to the open, high, low and close values so she selects the time study information to be viewed in conjunction with the open, high, low and close candlesticks that she already has displayed on her electronic trading device. After selecting the time study information to be displayed, she is now viewing the first candle sticks (e.g., corresponding to the open, high, low and close values), each being displayed with respective second candlesticks (e.g., corresponding to the calculated time study information) adjacent each of the first candlesticks.

The trader then wishes to see the second candlesticks displayed independently or at least separate from the first candlesticks to see if there is a trend change or shift of the trend-indicating values themselves. She then selects a view change and, as a result, the second candlesticks are viewed in a separate chart directly below a chart with the first candlesticks. Next, she notices that the second candlesticks have a shift in momentum. She discerns that there is a significant amount of volatility related to the tradeable object and she would like to adjust the timescale of how the second candlesticks are calculated and displayed. She, via her trading device, instructs the trading device to change the timescale of the second candlesticks, whereby the trading device alters the algorithm to calculate the second candlestick based on her inputs. Finally, the trader alters the scale of how the second candlesticks are displayed to better discern trends and/or movements of the second candlesticks. In some examples, the electronic trading device may automatically adjust how the second candlesticks are calculated based on automatically detecting market conditions and/or shifts in the tradeable object (e.g., shifts or movement of the tradeable object exceeding a pre-defined threshold, etc.). Viewing this information in this scenario allows the trader to be better informed and discern trend information in a relatively easy manner.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
receiving, at a computing device, a first market data update providing a first candlestick definition for a first time period, wherein the first market data update relates to a tradeable object offered at an exchange;
calculating, at the computing device, a baseline value related to the tradeable object, wherein the baseline value is based on the first market data update;
calculating, at the computing device, a second candlestick definition based on the first candlestick definition and the calculated baseline value, wherein the second candlestick definition is for a second time period that is different from the first time period;
defining, at the computing device, first and second candlesticks based on respective first and second candlestick definitions; and
displaying the defined first candlestick relative to the defined second candlestick as a part of a graphical representation of the market data update.

2. The method as defined in claim 1, wherein calculating the second candlestick definition comprises calculating a difference between the first candlestick definition and the calculated baseline value.

3. The method as defined in claim 1, wherein receiving the candlestick definition comprises receiving a realtime candlestick definition.

4. The method as defined in claim 1, wherein receiving the candlestick definition comprises receiving a stored candlestick definition from a repository accessible via a second computing device.

5. The method as defined in claim 1, wherein the candlestick definition comprises an open value, a high value, a low value and a close value.

6. The method as defined in claim 5, wherein the candlestick definition defines a candlestick body, an upper shadow and a lower shadow.

7. The method as defined in claim 6, wherein the candlestick body is defined based on the high value and the low value.

8. The method as defined in claim 5, wherein the baseline is calculated based on the high, low and close values.

9. The method as defined in claim 5, wherein the baseline is an average of the high, low and close values.

10. The method as defined in claim 1 wherein, the second time period is separated from the first time period by two or more market data updates.

11. The method as defined in claim 1, wherein the second candlestick definition is based on a second market data update.

12. A computing device comprising:
a user interface to receive or determine a first candlestick definition of a first time period, wherein the first candlestick definition is based on market update data that relates to a tradeable object offered at an exchange; and
a processor configured to execute instructions to:
calculate a baseline value related to the tradeable object, wherein calculating the baseline value is based on a portion of the market update data corresponding to a second time period, the second time period different from the first time period, and
calculate a second candlestick definition of the second time period based on the baseline value and the first candlestick definition,
wherein the user interface is to display graphical representations comprising first and second candlesticks representative of the first and second candlestick definitions, respectively, the candlestick graphical representations to be displayed relative to one another.

13. The computing device as defined in claim 12, wherein the displayed graphical representations of the first and second candlestick definitions are displayed at different scales relative to one another.

14. The computing device as defined in claim 12, wherein the displayed graphical representations of the first and second candlestick definitions are displayed adjacent to one another.

15. The computing device as defined in claim 12, wherein calculating the second candlestick definition is calculated as a difference between the baseline value and the first market data.

16. A tangible machine readable medium having instructions stored thereon, which when executed, cause a machine to:
receive a first set of market data defining a first candlestick definition for a first time period, wherein the first set of market data relates to a tradeable object offered at an exchange;
calculate a baseline value related to the tradeable object, wherein the baseline value is based on the first set of market data;
calculate a second candlestick definition based on a difference between values of the first candlestick definition and the calculated baseline value, wherein the second candlestick definition is for a second time period that is different from the first time period;
define first and second candlesticks based on respective first and second candlestick definitions; and
display the defined first candlestick relative to the defined second candlestick as a graphical representation of the market data update.

17. The machine readable medium having instructions stored thereon as defined in claim 16, wherein the baseline value is calculated using a portion of the market update data corresponding to the second time period.

18. The machine readable medium having instructions stored thereon as defined in claim 16, wherein the second candlestick is displayed on a separate chart from the first candlestick.

19. The machine readable medium having instructions stored thereon as defined in claim 16, which when executed, further cause the machine to adjust an algorithm used to determine the second candlestick.

20. The machine readable medium having instructions stored thereon as defined in claim 19, wherein the algorithm is adjusted based on a detected market condition.
